(19) United States
(12) Patent Application Publication
(10) Pub. No.: US 2025/0130988 A1
(43) Pub. Date: Apr. 24, 2025

(54) MANAGEMENT OF HIERARCHICAL PRODUCT PARAMETERS

(71) Applicant: DevRev, Inc., Palo Alto, CA (US)

(72) Inventors: Shlomi Vaknin, San Jose, CA (US); Dominik Damjakob, Austin, TX (US)

(73) Assignee: DevRev, Inc., Palo Alto, CA (US)

(21) Appl. No.: 18/919,232

(22) Filed: Oct. 17, 2024

Related U.S. Application Data
(60) Provisional application No. 63/544,772, filed on Oct. 18, 2023.

(51) Int. Cl. G06F 16/23; G06F 16/28

(52) U.S. Cl. CPC G06F 16/2365; G06F 16/282

(57) ABSTRACT

The present subject matter discloses techniques for managing modifications to hierarchical product parameters in a unified platform. A system receives user requests to modify hierarchical product parameters, processes the modifications, and records them in a pin table. Modifications may include updates to dependencies, adding/deleting links, or changing attributes. The system determines conflicts in the modifications, obtains recommended values from connected data sources, and compares user-preferred values with recommended values to identify inconsistencies. Users are notified of inconsistencies and prompted to validate modifications. The pin table is updated based on user validation. The system monitors parameters across developer-end and user-end ecosystems. A feedback loop allows users to review and approve/disapprove modifications. On approval, user-preferred values are retained. On disapproval, users can select recommended values to override their initial modifications. This approach maintains data integrity while allowing user customization.

### CROSS-REFERENCE TO RELATED APPLICATIONS

The present application claims the benefit of priority to U.S. Provisional Application 63/544,772, filed on Oct. 18, 2023, which is hereby incorporated by reference in its entirety.

### TECHNICAL FIELD

The subject matter described herein, in general, relates to managing hierarchical product parameters, and in particular to, recording modifications performed on hierarchical product parameters in a hierarchy of operational factors for an offering operating in a unified platform.

### BACKGROUND

Typically, offerings, such as products and services deployed in a computing environment touch upon, inhabit, or interrelate with numerous disparate locations, devices, and/or entities that pertain to the offerings. Each of these disparate locations, devices, and/or entities may inhabit a compartmentalized ecosystem that is distinct from—and effectively walled off from—any of the other compartmentalized ecosystems operating in the computing environment. Certain organizations may develop and deploy products and/or services in a connected computing environment. The connected computing environment in relation to a particular product and/or service of the organization includes one or more distinct ecosystems inhabited by user-end entities and developer-end entities of the particular product and/or service of the organization. Each of the one or more distinct ecosystems, while operating, produces a stream of data pertaining to events that describe an activity or change in the ecosystems. The events may generally be unique to each distinct ecosystem but may reference some entities that span the distinct ecosystems. The product and/or service and one or more entities associated with the product and/or service are common across all ecosystems and the events reference the common components of the product and/or service either directly or indirectly.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are not therefore to be considered limiting of its scope, the present subject matter will be described and explained with additional specificity and detail through the use of the accompanying drawings.

FIG. 1 provides an illustration of a connected environment, according to an example implementation of the present subject matter;

FIG. 2 illustrates a hierarchy of operational factors and interrelationships between the operational factors, according to an example implementation;

FIG. 3A illustrates a Part Discovery module for implementing an embodiment of the present subject matter;

FIG. 3B illustrates a system for recording modifications performed on a hierarchical product parameter in a hierarchy of operational factors for an offering operating in a unified platform, according to an example implementation of the present subject matter;

FIG. 4 illustrates a method for recording manually entered values by a user as user preferred values of a hierarchical product parameter in a hierarchy of operational factors for an offering operating in a unified platform, according to an example implementation of the present subject matter;

FIG. 5A illustrates a method for identifying and managing conflicting modifications of a hierarchical product parameter in a hierarchy of operational factors for an offering operating in a unified platform, according to an example implementation of the present subject matter;

FIG. 5B illustrates a method for prompting a user for validating conflicting user preferred values of a hierarchical product parameter in a hierarchy of operational factors for an offering operating in a unified platform, according to an example implementation of the present subject matter;

FIG. 6 illustrates a process of pinning the actions in accordance with the present subject matter;

FIG. 7 illustrates a block diagram of an illustrative computing system suitable for implementing an embodiment of the present invention.

### DETAILED DESCRIPTION

In modern connected computing environments, organizations frequently develop and deploy a wide range of products, services, and solutions across multiple discrete ecosystems. The products, services, and solutions may be collectively referred to as an offering, and may encompass any deliverable that an organization may provide to its users or customers. Further, in connected computing environments, events related to offerings are often organized into hierarchical structures. The hierarchical structure typically includes a hierarchy of operational factors centered around a product or service, which serves as the primary entity to which all hierarchical product parameters are related and branched. In an example, an operational factor may refer to a component or piece of the hierarchy of operational factors associated with the offering deployed in the connected environment. Exemplary operational factors include a capability, a feature, a microservice, and the like. The hierarchical product parameter may refer to an operational factor in the hierarchy of operational factors. Within the hierarchy of operational factors, tickets, issues, or work items are commonly associated with specific hierarchical product parameters of the offering.

Conventional approaches taken by software or service organizations face immense struggles to effectively monitor and manage the hierarchical product parameters in the hierarchy of operational factors. For example, one conventional approach is to use a manual process to monitor and manage the hierarchies of operational factors pertaining to products or services. In such conventional approaches, any modifications occurring in the hierarchical product parameters in the hierarchy of operational factors may be manually recorded and updated. The conventional manual approach, however, presents several challenges. Manual management of hierarchies of operational factors by recording and monitoring large volumes of data streams may require a significantly high level of human effort and may be time-consuming and prone to human error. Moreover, as products and services evolve rapidly in response to market demands and technological advancements, manually recorded hierarchies may struggle to keep pace with the latest deployments and updates, which may result in creating an outdated or inaccurate representations of the product or service in the hierarchy of operational factors. In an example, any inaccuracy in the representations of the product or service may lead to inefficiencies in issue tracking, resource allocation, and overall product management.

Further, any discrepancy between an actual state of the offering and its representation in the hierarchy of operational factors may have adverse consequences. For instance, any discrepancies in the hierarchy of operational factors may lead to misallocation of resources, delays in issue resolution, and difficulties in tracking the progress of feature implementations or bug fixes. Furthermore, the discrepancies in the hierarchy may hinder effective communication between different teams within an organization, such as development, quality assurance, and customer support.

In one scenario, the modifications may be initiated by a user. In such scenarios, it may be difficult for the conventional systems to efficiently track and manage the user-initiated modifications. Further, it may also be difficult to identify any discrepancy in the user-initiated modifications. The difficulty may lead to creating an inaccurate representation of the product or service in the hierarchy of operational factors. In an example, the user may interact with a hierarchical product parameter and may modify the hierarchical product parameter. The user-initiated modifications in the hierarchical product parameter may, in some situations, give rise to a conflict between a user-modified value and a system recommended value. Thus, the modifications implemented in the hierarchical product parameter may create inconsistencies in data leading to an inaccurate and unreliable representation of the product or service in the hierarchy of operational factors.

The present subject matter discloses techniques to manage hierarchical product parameters for an offering within a unified platform. According to one exemplary embodiment, the present subject matter provides systems and methods for recording and updating modifications to a hierarchical product parameter in a hierarchy of operational factors for the offering. The offering may be a product, a service, or a combination of both. Further, the offering may have components operating in distinct ecosystems in a connected computing environment. The distinct ecosystems may be connected through the unified platform where an organization may integrate and manage various aspects of an offering's operations, resources, and processes. The unified platform may be implemented as a Software-as-a-Service (SaaS) platform. The unified platform acts as a central hub unifying the distinct ecosystems within which various components of the offering operate, thereby enabling a holistic approach to generate and maintain accurate hierarchical product parameters. For instance, the unified platform may integrate data from a development ecosystem (e.g., code repositories, build systems), an operations ecosystem (e.g., deployment logs, performance monitoring), and a customer-facing ecosystem (e.g., support tickets, usage analytics).

The hierarchical product parameter may be understood as a parameter associated with a specific level of granularity in the hierarchy of operational factors associated with the offering. The operational factors associated with the offering may span over the plurality of distinct ecosystems operating in relation to the product deployed in the connected environment. For instance, the operational factors may be divided amongst user-end entities and/or developer-end entities responsible for generating them or fixing them.

The hierarchy of operational factors associated with the offering, such as the product or service includes the product or service as the origin entity. The product or service may have one or more capabilities, which are the core unit a user-end entity interacts with and to which revenue can be assigned. Capabilities may have an associated API namespace if delivered as a software product or service. Each capability may comprise an independent set of features, where features define product offerings that can be measurable, observable, upgradable, and potentially monetizable. In an example, the capabilities and/or features may link to backend constructs, termed microservices, most commonly, if the product/service is a software product or service. A microservice may be referred to as a unit of deployment and may be an operational factor which composes a feature or capability.

The term “operational factor” thus refers to a component or piece of the hierarchy of operational factors associated with the product and/or service deployed in the connected environment. Exemplary operational factors include a particular capability, feature, microservice, sub-module, and the like. The term “hierarchical product parameter” refers to an operational factor in the hierarchy of operational factors for a particular ecosystem of the connected environment. In an example, for each specific ecosystem, there may be a hierarchy of the operational factors associated with the product and/or service and one or more hierarchical product parameters in relation to the operational factors. In an example, the hierarchical product parameter may be a part of the product or service and the hierarchy of operational factors may be a part hierarchy centered around the product or service. The terms offering, product, and service have been used interchangeably throughout the specification.

In an example implementation, the system records and updates modifications to the hierarchical product parameter in the hierarchy of operational factors based on a request received from a user. The user may request to modify the hierarchical product parameter. For example, consider a cloud-based software service where the hierarchical product parameters may include the product itself (e.g., Cloud Storage Service), its pricing structure, subscription tiers (Basic, Premium, Enterprise), features, and specific attributes like storage capacity, data transfer limits, and backup frequency. A user may request to modify the hierarchical product parameters for the cloud-based software service. For instance, the user may request to modify the storage capacity for the basic subscription tier from a lower storage value to a greater storage value.

Once a modification request is received, the request for the modification of the hierarchical product parameter may be processed to obtain a modified hierarchical product parameter. The modified hierarchical product parameter represents the user's preferred values for the hierarchical product parameter. The modified hierarchical product parameter with the modifications is then recorded in a database. In an example, the database may utilize a pin table within the database to store the modifications in the hierarchical product parameters. The pin table is a specialized database structure designed to efficiently record and track modifications to hierarchical product parameters.

In an example implementation, a conflict in the modifications, recorded in the pin table, may be determined. For example, the conflict may be discrepancy between the user preferred values and the system recommended values of the hierarchical product parameter, or contradictory changes made by different users, or changes that violate predefined rules or dependencies within the product hierarchy. In an example implementation, to ensure that the modifications are not made in isolation by the user, the system obtains recommended values for the hierarchical product parameters. The recommended values of the hierarchical product parameters are derived from a plurality of connected data sources, each operated in connection with the unified platform.

In an example implementation, user preferred values of the recorded modified hierarchical product parameter are compared with the recommended values of the hierarchical product parameter to identify inconsistent values of the hierarchical product parameter. Upon identifying inconsistent values, the user may be notified, prompting them to validate their proposed modifications. In an example, the notification includes the recommended values of the hierarchical product parameter, providing the user with the context and data-driven insights necessary to make an informed decision. The notification step prevents any potentially detrimental changes to hierarchical product parameters while still respecting the user's authority to make final decisions. Finally, based on the user's validation, i.e., whether they choose to proceed with their original modification, adopt the system's recommendation, or input a new value, the pin table is updated. The system thereby ensures that the final, validated changes are accurately recorded and reflected in the system.

The present subject matter thus provides a flexible and efficient approach for managing user-initiated modifications and updating the hierarchy of operational factors while maintaining data integrity and relationships. By automatically recording and storing user modifications in a dedicated pin table, the system automates a significant portion of the data integration process, thereby reducing manual effort and potential errors. The system also allows users to actively participate in shaping the product or service hierarchy while providing safeguards against unintended consequences, thereby striking a balance between user freedom and system stability. Moreover, by combining user modifications with system recommended values associated with the hierarchical product parameter and implementing a validation process, the invention significantly enhances overall data integrity and reliability. These technical advantages collectively contribute to a more efficient, reliable, accurate, and manageable system for managing the hierarchy of operational factors for the offering, addressing key challenges faced in conventional systems.

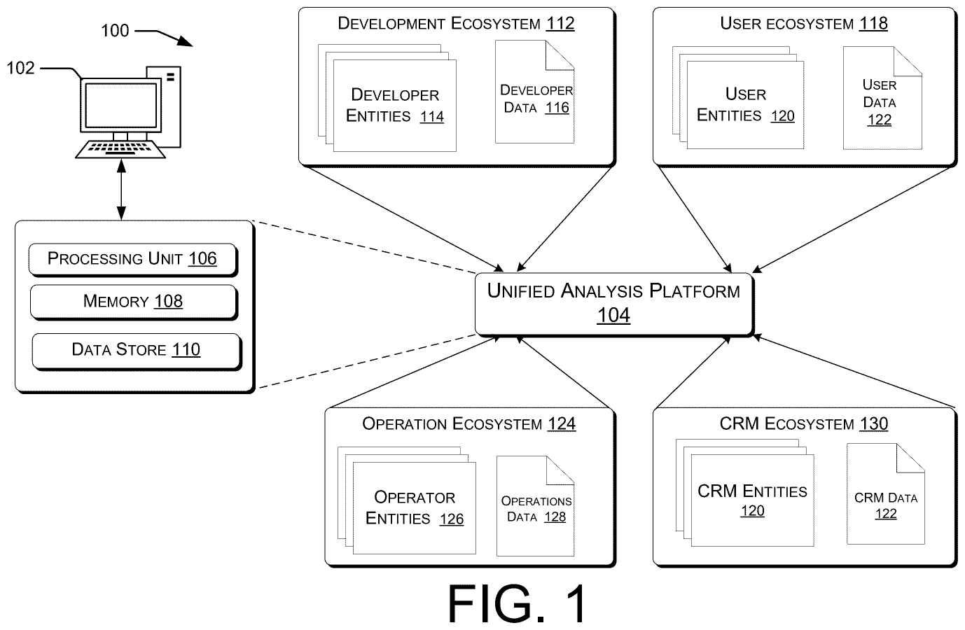

The present subject matter is further described with reference to FIGS. 1-7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 provides an illustration of a connected environment 100, in accordance with an example implementation of the present subject matter. The connected environment 100 may include multiple entities operating in relation to an offering. The offering may be onboarded with a unified analysis platform 104 and the unified analysis platform 104 may be responsible for supporting and maintaining distinct functions in relation to the offering. The unified analysis platform 104 may incorporate technologies such as cloud computing, containerization, microservices architecture, and the like.

The connected environment 100 may be controlled by a system (not shown). The system may include a user station 102 to operate a unified analysis platform 104. The user station 102 that hosts the unified analysis platform 104 includes any type of computing device that may be used to implement, operate, or interface with the unified analysis platform 104. The computing device may include, for example, workstations, personal computers, mobile devices, servers, hosts, nodes, or remote computing terminals. The user station 102 comprises a display device, such as a display monitor, for displaying an interface to users at the user station. The user station 102 also includes one or more input devices (not shown) for a user to achieve operational control over the activities of the connected environment 100. The input devices may include a mouse and/or keyboard to manipulate a pointing object in a graphical user interface to generate user inputs.

The user station 102 may be communicably coupled to a processing unit 106, a memory 108, and a data store 110. The processing unit 106 enables the user station 102 to run at least one operating system and other applications and services. The processing unit 106, amongst other capabilities, may be configured to fetch and execute computer-readable instructions stored in the memory 108. The processing unit 106 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine-readable instructions.

The functions, performed by the processing unit 106, may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the user station 102 to interact with different components. Further, the interface may enable the user station 102 to communicate with entities, for example, the entities operating in the various distinct ecosystems, web servers, and external repositories. The interface may facilitate multiple communications within a wide variety of networks and protocol types, including wireless networks, wireless Local Area Network (WLAN), Radio Access Network (RAN), satellite-based network, and the like.

The memory 108 may be coupled to the processing unit 106 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

The operation of the unified analysis platform 104 involves analysis of large amounts of data streams captured from the distinct ecosystems to identify events occurring at the distinct ecosystems for processing by the unified analysis platform 104. The unified analysis platform 104 implements autonomous clustering of the events to generate hierarchies of operational factors associated with the products as well as autonomous classification and communication between these hierarchies.

Any number or type of events generated by distinct ecosystems may be acted upon by embodiments of the invention. For example, the connected environment 100 includes a development ecosystem 112 having developer entities 114 and generating developer data 116, a user ecosystem 118 comprising user entities 120 and generating user data 122, an operation ecosystem 124 comprising operator entities 126 and generating operations data 128, a Customer Relationship Management (CRM) ecosystem 130 comprising CRM/Revenue-based entities 132, and generating CRM data 134. For the sake of understanding, the development ecosystem 112 and operation ecosystem 124 may be collectively referred to as developer-end ecosystems, and the user ecosystem 118 and CRM ecosystem 130 may be collectively referred to as user-end ecosystems.

In some embodiments, the unified analysis platform 104 uses machine-learning based techniques to automatically process the data and events generated by the distinct ecosystems to generate a hierarchy of operational factors associated with the product or service. The unified analysis platform 104 stores both raw data generated by each distinct ecosystem and the hierarchical product parameters map illustrating properly categorized data at the data store 110, so that the processing unit 106 can be used to accurately identify useful and accurate hierarchical product parameters. In an example implementation, the unified analysis platform 104 records and updates modifications to a hierarchical product parameter in the hierarchy of operational factors for the offering. The unified analysis platform 104 stores the data associated with the modifications in the hierarchical product parameter at the data store 110. The present subject matter outlines an application of the inventive method for the Software-as-a-Service (SaaS) industry, but it is not limited to this industry.

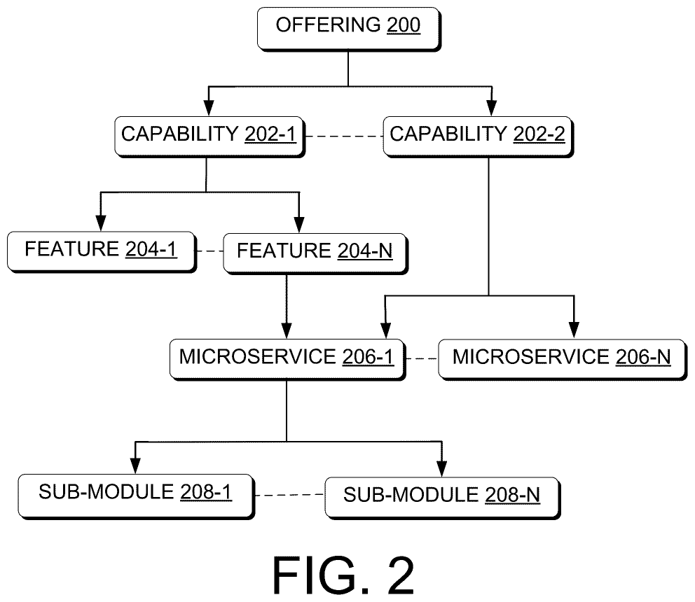

FIG. 2 illustrates a comprehensive framework comprising hierarchical product parameters for an offering. The comprehensive framework standardizes a hierarchy of product parameters ensuring consistency and coordination across all entities and data from the discrete ecosystems in the unified analysis platform 104 (discussed with reference to FIG. 1). Each element in the hierarchy may be referred to as a hierarchical product parameter. The structure and specific product parameters of the hierarchy may vary depending on a type of the offering. Though the description here focuses on software-based offerings, the comprehensive framework may be adapted for other products or services.

The offering 200 forms the foundational entity for which the hierarchy is constructed. The offering 200 is defined as a unit of profit and loss, identity, onboarding, and contracting purposes. The offering 200 may encompass multiple hierarchical product parameters, arranged in a top-down structure of increasing granularity. At the highest level of granularity, the offering 200 may include capabilities such as capabilities 202-1, 202-2, . . . , and 202-N. The capabilities 202-1, 202-2, . . . , and 202-N may be singly referred to as a capability 202 and collectively referred to as capabilities 202. The capability 202 represents a core functional unit with which an end user may directly interact. For example, in a customer relationship management (CRM) software offering, the capabilities 202 may include “Contact Management,” “Sales Pipeline,” or “Email Marketing.”

At the next level of granularity, each capability 202 may be composed of one or more features 204, such as features 204-1, . . . , and 204-N. The features 204-1, . . . 204-N may hereinafter be singly referred to as a feature 204 and collectively as features 204. The feature 204 is another hierarchical product parameter having a specific functionality within a capability 202. The feature 204 is typically not directly interacted with by the end-user but may be essential to the operation of the capability 202. For instance, within the “Contact Management” capability as discussed above, features, may include “Contact Deduplication,” “Custom Fields,” or “Activity Tracking.”

In software-based offerings, the capabilities 202 and/or the features 204 are often supported by backend constructs, which form additional levels in the hierarchy of product parameters. The additional levels may include microservices 206-1, 206-2, . . . 206-N and sub-modules 208-1, . . . 208-N. The microservices 206-1, 206-2, . . . 206-N may hereinafter be singly referred to as a microservice 206 and collectively as microservices 206. Similarly, the sub-modules 208-1, . . . 208-N may hereinafter be singly referred to as a sub-module 208 and collectively as sub-modules 208. The microservices 206 and the sub-modules 208 may represent the technical implementation of the higher-level functionalities. For instance, the “Contact Management” capability, as discussed above, may be supported by microservices 206 such as “Contact Data Storage”, “Contact Search”, and “Contact Synchronization”. The microservices 206 may further rely on sub-modules 208 such as database connectors, caching mechanisms, or third-party Application Programming Interface (API) integrations.

The microservice 206 may be a deployable unit of software that may support one or more features 204 or contribute to a capability 202. As illustrated in FIG. 2, the feature 204-N may be based on the microservice 206-1. In another example implementation as depicted in FIG. 2, the capability 202-N may be formed based on a combination of microservice 206-1 and the microservice 206-N. Further, the microservice 206-1 may be implemented using the sub-module 208-1 and the sub-module 208-N. The sub-module 208 may be meant as part of an entity in the connected environment 100, but not the entity as a whole.

For software-based offerings, the offering 200 may have an Application Programming Interface (API) namespace and associated service level agreements (SLA). The capability 200 may be conceptualized as a set of entities (noun) and activities (verbs) associated with the each provided entity. Each capability 202 may have configurable elements that manifest as one or more features 204 or contribute to the capability 202. Extending the noun/verb analogy used above, the feature 204 may define specific attributes (adjectives) of functions performed at an entity within one of the distinct ecosystems explained in relation to FIG. 1.

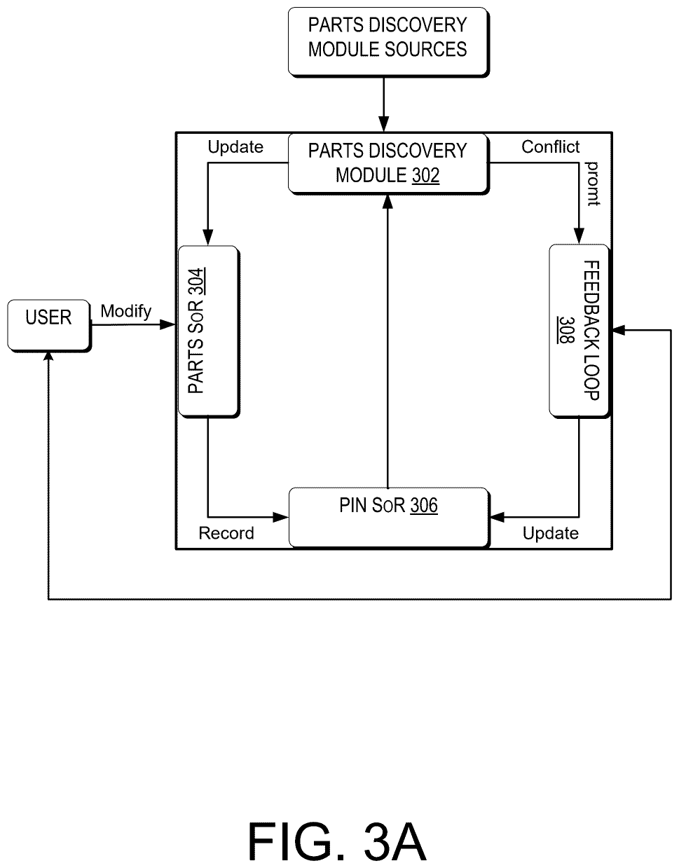

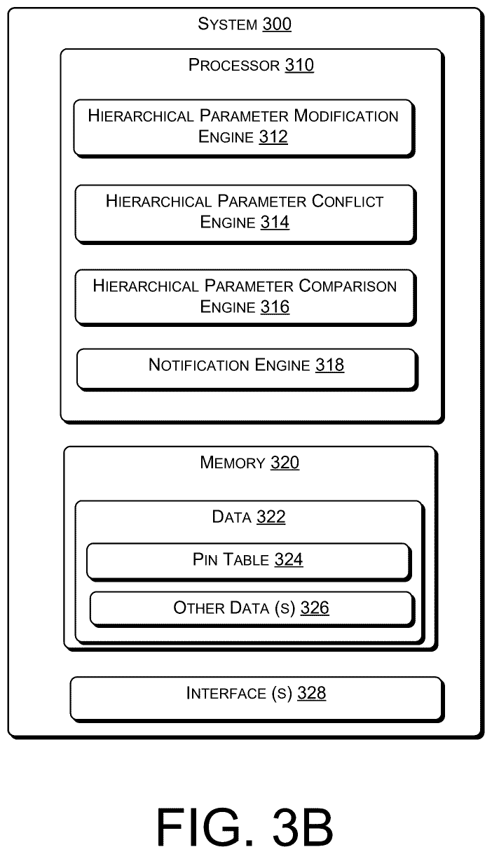

FIG. 3A illustrates a Part Discovery module for implementing an embodiment of the present subject matter. FIG. 3B illustrates a system for recording modifications performed on a hierarchical product parameter in a hierarchy of operational factors for an offering operating in a unified platform, according to an example implementation of the present subject matter. For the sake of brevity, FIG. 3A has been explained in conjunction with FIG. 3B.

The system may include a module called a ‘Part Discovery module’ in the existing system or event hierarchy, wherein in accordance with the present specification system or event hierarchy is also known as ‘Product or service hierarchy”. The event hierarchy, known as ‘Product or service hierarchy”, is also referred to as a hierarchy of operational factors. Further, a part of the offering, such as a part of a product or a part of a service is also referred as a hierarchical product parameter. The Part Discovery module of the present product or service executes monitoring and managing the existing Product or service, updating the Parts, and creating new Parts (components like Capability or Features). The existing system or event hierarchies experience drastic consequences in terms of managing the structure of hierarchy when the user-defined values overwrite the existing Parts and when other actions like deleting the existing Parts, changing the path of the existing Parts, merging the Parts, splitting the Parts, or adding new Parts go unrecorded. Restricting the user activities to modify the Parts only when no adverse action is recorded from the user at any point prior in time, and always taking the input of the former user as a pure source of truth and not allowing overwriting will limit the abilities of the Part Discovery module to keep the Parts and their trails up to date. There is a need for a system that can allow its users to modify the Parts and interact actively with the discovered Parts, and also needs to monitor, record, and track the modified values.

In one of the exemplary embodiment, the Part Discovery module 302, as shown in FIG. 3A, comprises a pinning module that records every action on each of the Parts (all tier components) in the Product or service and stores these pinned records in a Pin Table 306. When a user modifies a Part in terms of changing the dependency (of lower-tier Parts with upper-tier Parts or dependence between same-tier Parts), deleting the links, adding new connections, or modifying the existing Parts (editing the name or other attributes defined in a Part) then the pinning module records all such actions and stores in the Pin table 306. The Part Discovery module 302 runs frequently and identifies any conflicting values in the Part-pins (a Part which is overridden by pinned values repeatedly), then the Part Discovery module 302 prompts the user to validate the pinned values through a feedback loop 308, wherein the Part Discovery module 302 provide suggestions for the field value in contrast with the pinned values from other discovered Parts, thereby allowing the user to decide on approval or rejection of the pinned values. Upon update from the user, the Part Discovery module will update the discovered value in the Part and the Part Table 304.

The Part Discovery module 302 will prompt the user through feedback loop 308 to review the pinned values after significant time passed and if there is a conflict between the discovered Parts and pinned values. This periodical prompt allows the user to understand the discovered data values by the Part Discovery module. It enables the user to decide whether to use the manually entered value (modified value by the user), which overrides the Part Discovery module automation or to invalidate the pinned value and allow the Part Discovery module to update the discovered value to the Part.

FIG. 3B illustrates a system 300 for managing modifications performed on a hierarchical product parameter of an offering, such as a product or a service in a hierarchy of operational factors associated with the offering, according to an example implementation of the present subject matter. In an example, the system 300 may be implemented in the connected environment 100. The system 300 may monitor, record, and update modifications in the parts, i.e., hierarchical product parameters for a cloud-based infrastructure offering a wide range of services. In some cases, the system 300 may modify and update the hierarchical product parameters to provide an updated representation of the product hierarchy, including information on component performance, customer issues, and manufacturing status. The system 300 may include a processor 310, a memory 320, and an interface 328.

The processor 310 may correspond to the processing unit 106 and the memory 320 may correspond to the memory 108. The processor 310 may include one or more engines 312, 314, 316, 318. The engines may correspond to the parts discovery module 302. The processor 310, amongst other capabilities, may be configured to fetch and execute computer-readable instructions stored in the memory 320.

The memory 320 may be coupled to the processor 310 and may, among other capabilities, provide data and instructions for generating different requests. The memory 320 may include data 322 corresponding to the record of hierarchical product parameters associated with the offering. The interface(s) 328 may include a variety of machine-readable instructions-based interfaces and hardware interfaces that allow the system 300 to interact with different entities in the connected environment. Further, the interface 328 may enable the components of the system 300 to communicate with computing devices, web servers, and external repositories. The interface may facilitate multiple communications within a wide variety of networks and protocol types, including wireless networks, wireless Local Area Network (WLAN), RAN, satellite-based network, and the like.

The engines 312, 314, 316, 318 may include routines, programs, objects, components, data structures, and the like, which perform particular tasks or implement particular abstract data types. The engines 312, 314, 316, 318 may further include modules that supplement applications on the system 300, for example, modules of an operating system. Further, the engines 312, 314, 316, 318 may be implemented in hardware, instructions executed by a processor, or by a combination thereof.

In an implementation, the engines 312, 314, 316, 318 may be machine-readable instructions which, when executed by the processor 310, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 312, 314, 316, 318 may perform different functionalities. The engines 312, 314, 316, 318 may include a hierarchical parameter modification engine 312, a hierarchical parameter conflict engine 314, a hierarchical parameter comparison engine 316, and a notification engine 318. The functions of the engines 312, 314, 316, 318 are explained below.

The system 300 may monitor and record user actions on all hierarchical product parameters within the hierarchy of operational factors for the offering. The system 300 may capture and log every action performed on each hierarchical product parameter, regardless of its tier or position in the hierarchy. In an example, the user actions may include modifications carried in the dependencies between hierarchical product parameters, such as changing relationships between lower-tier and upper-tier hierarchical product parameters or altering connections between hierarchical product parameters on the same tier. In another example, the user actions may include modifications in the hierarchical product parameters, such as deleting existing links or connections between hierarchical product parameters or establishing new connections or relationships between hierarchical product parameters. In another example, the user actions may include modifications in attributes of the hierarchical product parameters, such as names, descriptions, or any other defined characteristics of the hierarchical product parameter.

In an example implementation, a user may request to modify the hierarchical product parameter in the hierarchy of operational factors for the offering. As discussed above, the modifications of the hierarchical product parameter may include at least one of an update in the dependency of the hierarchical product parameter, or an addition of a link in the hierarchical product parameter, or a deletion of a link associated with the hierarchical product parameter, or a modification in attributes of the hierarchical product parameter. On receiving the modification request from the user, the hierarchical parameter modification engine 312 processes the request to obtain a modified hierarchical product parameter. In an example implementation, the processing of the request may include interpreting the user's input, validating it against existing parameters and rules, and preparing it for integration into the system. The modified hierarchical product parameter represents the user's preferred values for the hierarchical product parameter.

The modified hierarchical product parameter with the modifications is then recorded in a database. In an example, the database may utilize a pin table within the database to store the modifications in the hierarchical product parameters. The pin table is a specialized database structure designed to efficiently record and track modifications to hierarchical product parameters. All recorded modifications may be stored as pinned records in the pin table. The pin table may serve as a comprehensive log of all user-initiated changes to the hierarchy of operational factors for the offering. For instance, the pin table may include one or more fields, such as User ID (indicating who made the modifications in the hierarchical product parameter), Parameter ID (indicating which parameter has been changed), original value, modified value, timestamp, and modification status (pending, approved, rejected). The recording of the modifications in the pin table may allow for efficient tracking of all modifications, thereby providing a clear audit trail and enabling easy rollback of modifications, if necessary.

In an example implementation, the hierarchical parameter conflict engine 312 may determine conflicts in the modifications recorded in the pin table. The hierarchical parameter conflict engine 314 may operate on a frequent basis to analyze the pin table for identifying the conflicts. For example, conflicts may arise when multiple pinned records exist for the same hierarchical product parameter attribute, when a hierarchical product parameter is repeatedly modified indicating uncertainty or discrepancy about its characteristics, or when the pinned records including the user preferred values for a hierarchical product parameter contradict automatically discovered or system recommended values.

For example, if one user names a hierarchical product parameter while the system finds a better name for the hierarchical product parameter from a connected data source, the system would flag this as a conflict requiring resolution. In another example, if one user increases the storage limit for the basic tier of a product while another decreases it, the system would flag this as a conflict requiring resolution. In an example implementation, to ensure that the modifications are not made in isolation by the user, the system 300 obtains recommended values for the hierarchical product parameters. The recommended values of the hierarchical product parameters are derived from a plurality of connected data sources, each operated in connection with the unified platform. The data sources may include code repositories, deployment logs, monitoring systems, customer support databases, user analytics platforms, and the like.

Upon detecting the conflict, the hierarchical parameter comparison engine 316 compares the user-preferred values (the values input by the user in their modification request) with the recommended values (the values derived from the connected data sources). The comparison aims to identify any inconsistent values, i.e., instances where the user's preferred modification significantly diverges from the system's recommendations. For example, if a user attempts to set the price for a premium subscription tier at $x per month, but the system's analysis of market data and competitor pricing suggests a recommended price of $y per month, this would be flagged as an inconsistent value.

Based on the identification of inconsistent values, the notification engine 318 may initiate a user validation process. The user validation process may include notifying the user about the detected conflict and/or inconsistent value and prompting the user to validate the proposed modifications. The user may be presented with the conflicting user-preferred values alongside the system-generated recommended values of the hierarchical product parameter to resolve the conflict. In an example, the notification engine 318 may also provide context for the conflict, including historical data or related hierarchical product parameter information. In an example, the notification engine 318 may initiate a user validation process through a feedback loop. Through the feedback loop, users may be empowered to make informed decisions about conflicting values. In an example, the notification engine 318 may transmit the identified inconsistent values of the hierarchical product parameter to the feedback loop and the feedback loop prompts the user to review the user preferred values of the recorded modified hierarchical product parameter.

In an example, the user may choose to approve one of the user preferred values of the hierarchical product parameter in the hierarchy of operational factors. In such scenarios, the notification engine 318 may retain the modified hierarchical product parameter with the user preferred values of the hierarchical product parameter in the pin table. Alternatively, the user may choose to disapprove one of the user preferred values of the hierarchical product parameter in the hierarchy of operational factors. In such scenarios, the notification engine 318 may select recommended value of the hierarchical product parameter derived from the plurality of connected data sources associated with the hierarchical product parameter. Upon selection of the recommenced value by the user, the user preferred values of the hierarchical product parameter are overridden with the selected recommended value of the hierarchical product parameter.

The notification engine 318 may initiate an update process based on the user's decision. The notification engine 318 updates the pin table based on the user validation. In an example, the chosen value may be recorded as the current validated value for the hierarchical product parameter attribute. In another example, the hierarchical product parameter may be updated with the validated value. Further, the part table, which serves as the primary data store for the hierarchy of operational factors for the offering, may be updated to reflect the validated value.

The present subject matter thus provides a flexible and efficient approach for managing user-initiated modifications and updating the hierarchy of operational factors while maintaining data integrity and relationships. The system allows users to freely modify hierarchical product parameters within the hierarchy of operational factors while still maintaining data integrity, thereby providing a flexible approach which enhances user interaction and customization capabilities. By automatically recording and storing user modifications in a dedicated pin table, the system provides a robust audit trail record of all changes and modifications made to the hierarchical product parameters.

The present subject matter actively monitors and compares system recommended values with user preferred values, enabling the system to identify conflicts between user modifications and system recommended values. Further, in scenarios when conflicts are detected, the system prompts the user to review and validate their modifications through a feedback loop, thereby ensuring data accuracy and user awareness of existing issues. Furthermore, during the review process, the system notifies the user with appropriate suggestions derived from the connected data sources, helping users to make informed decisions about whether to retain their modifications or accept the suggested recommended values. Based on the user validation, the system dynamically updates both the pin table and the database, ensuring that all the components of the unified platform reflect the accurate and updated information.

The system can act upon any number or type of event hierarchies, making the system highly scalable and adaptable to various product or service structures. By automatically recording and storing user modifications in a dedicated pin table, the system automates a significant portion of the data integration process, thereby reducing manual effort and potential errors. The system allows users to actively participate in shaping the product or service hierarchy while providing safeguards against unintended consequences, thereby striking a balance between user freedom and system stability. Moreover, by combining user modifications with system recommended values associated with the hierarchical product parameter and implementing a validation process, the invention significantly enhances overall data integrity and reliability. These technical advantages collectively contribute to a more efficient, reliable, accurate, and manageable system for managing the hierarchy of operational factors for the offering, addressing key challenges faced in conventional systems.

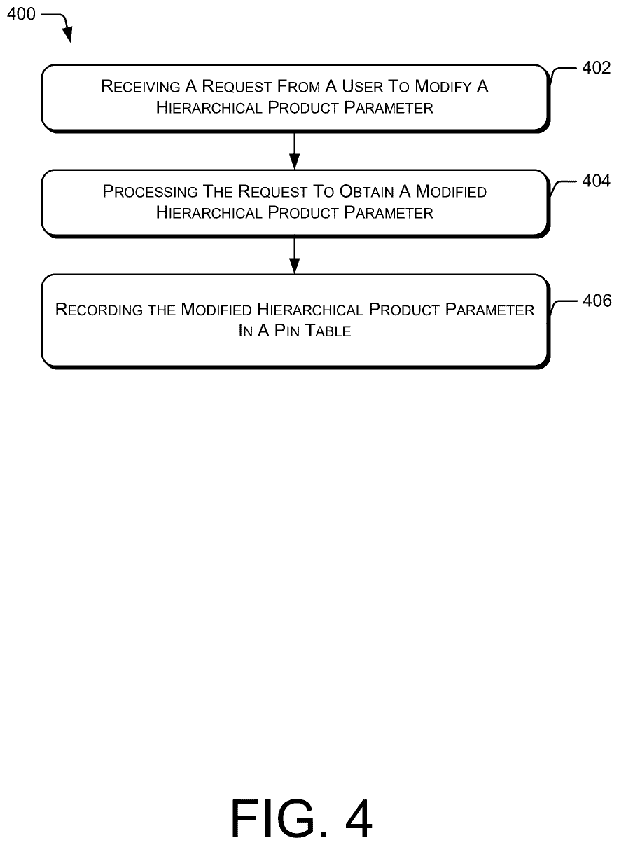

FIG. 4 illustrates a method 400 for recording manually entered values by a user as user preferred values of a hierarchical product parameter in a hierarchy of operational factors for an offering operating in a unified platform, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 400 may be performed by the system 300 in the connected environment 100.

The hierarchical product parameters in the hierarchy of operational factors for the offering may be continuously monitored. In an example, the monitoring of the hierarchical product parameters may include real-time tracking of user interactions with the system, periodic scans of the entire hierarchy of operational factors to detect any changes, or an event-driven monitoring triggered by an action. The interaction of the user with the hierarchical product parameter may be recorded as the user preferred values.

At step 402, the method 400 includes receiving a request from the user to modify a hierarchical product parameter. In an example, the modification request may be grouped into three types: an edit modification, an add modification, and a delete modification. In the edit modification, existing attributes or properties of the hierarchical product parameter may be modified. In the add modification, new hierarchical product parameters may be created or new attributes may be added to the existing hierarchical product parameter. In the delete modification, hierarchical product parameters or the attributes of the hierarchical product parameter may be removed from the hierarchy of operational factors for the offering. In an example, each modification request may be timestamped and associated with the user who initiated the request.

At step 404, the method 400 includes processing the request for the modification of the hierarchical product parameter to obtain a modified hierarchical product parameter. The user preferred values entered or modified by the user may be captured and processed to incorporate the modifications suggested by the user. In an example, the user preferred values may be temporarily held in a buffer for processing before being stored.

At step 406, the method 400 includes recording the modified hierarchical product parameter in a database for storing the modifications of the hierarchical product parameter. The modifications are recorded in a pin table in the database. A new entry may be created in the pin table for each recorded user preferred values. In an example, the entry may include a hierarchical product parameter identifier, an attribute being modified, a new value, a timestamp of modification, a user identifier, and relevant metadata. In an example implementation, the pin table may maintain a history of all modifications. For instance, if a user preferred value already exists for the same hierarchical product parameter and attribute, a new version of the user preferred value may be created, and the existing entry may be updated with the new value and timestamp.

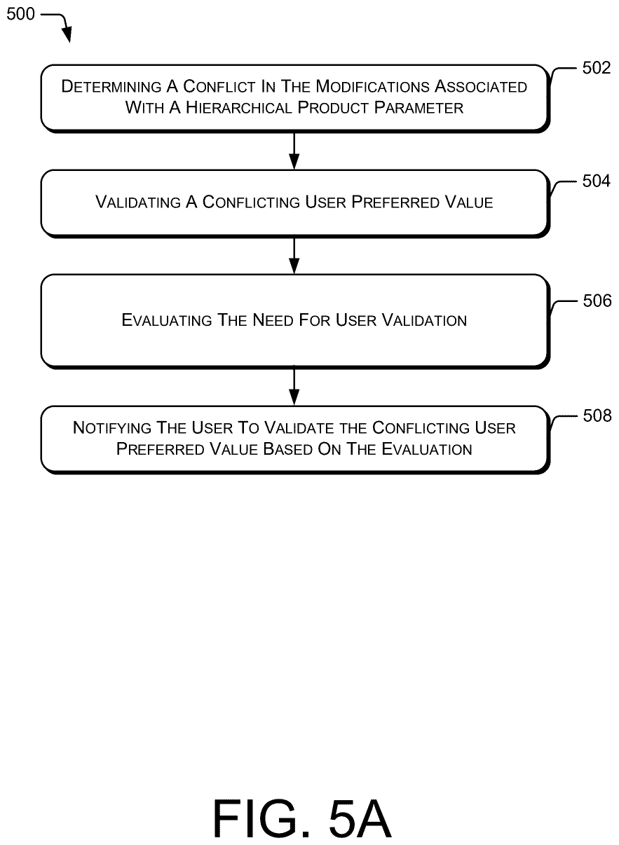

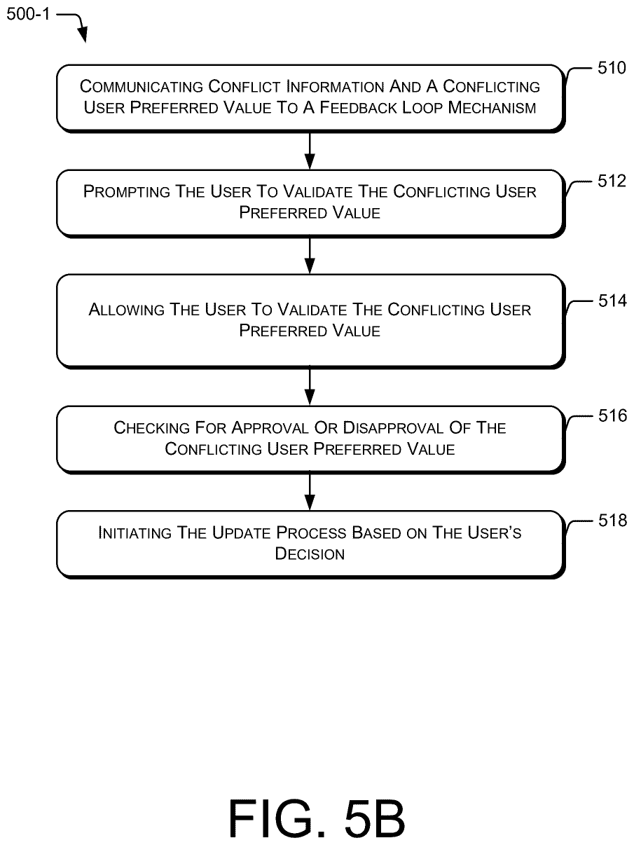

FIG. 5A illustrates a method 500 for identifying and managing conflicting modifications of a hierarchical product parameter in a hierarchy of operational factors for an offering operating in a unified platform, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 500 may be performed by the system 300 in the connected environment 100.

At step 502, the method 500 includes determining a conflict in the modifications associated with the modified hierarchical product parameter recorded in the pin table. A conflicting user preferred value may be identified to determine the conflict in the modifications. In an example, the pin table may be scanned to locate all the recorded user preferred values associated with the hierarchical product parameter in the hierarchy of operational factors to identify the conflicting user preferred value. In an example, for each recorded user preferred values, information such as a hierarchical product parameter identifier, an attribute that was recorded, and metadata like timestamp of the record and the user who created the record may be retrieved.

At step 504, the method 500 includes validating the conflicting user preferred value. For each recorded user preferred values, a validation process may be initiated to determine if there are any conflicts. The validation process may include semantic analysis to detect subtle conflicts in textual data, numerical range checks for quantitative attributes, and logical consistency checks across related hierarchical product parameters or attributes. In an example, the recorded user preferred value may be compared with the current value in a hierarchical product parameter map within the hierarchy of operational factors. The hierarchical product map is referred to as the part table. In another example, the recorded user preferred values may be compared with the recommended values of the hierarchical product parameter to identify inconsistent or conflicting values of the hierarchical product parameter. The recommended values of the hierarchical product parameter may be derived from a plurality of connected data sources. The data sources might include market analysis tools providing insights on competitor pricing and features, customer usage statistics showing popular features or common upgrade paths, financial systems providing data on costs and profit margins, and customer feedback systems highlighting requested features or improvements.

On identifying a discrepancy or inconsistency in the validation process, the method 500 may flag the recorded user preferred value associated with the inconsistent values as the conflicting user preferred value. In an example, the conflicting user preferred value may be categorized, such as direct value conflicts (for example, different numerical values for the same attribute), semantic conflicts (for example, similar but non-identical textual descriptions), and structural conflicts (for example, changes in hierarchical product parameter relationships or hierarchy).

At step 506, the method 500 includes evaluating the need for user validation. In an example, a predefined criteria may be applied to determine if user validation is necessary. The predefined criteria may include the severity or impact of the conflict, the time elapsed since the last user interaction with the hierarchical product parameter, the frequency of conflicts for the hierarchical product parameter or attribute. Based on the predefined criteria, it may be decided whether to prompt for user validation or to apply automated resolution rules.

At step 508, the method 500 proceeds to prompting the user to validate the conflicting user preferred value. If user validation is deemed necessary, a prompt may be initiated through a feedback loop. In an example, the user may be notified to validate the modifications based on the identified inconsistent values. The notification may include recommended values of the hierarchical product parameter for the conflicting user preferred values. The notification may also present a comparison between the recorded user preferred value and the system recommend value, provide a context about the conflict and impact of the conflict on the hierarchy, and offer options for resolution. The notification may be delivered through various channels, such as in-app notifications, email alerts, or dashboard messages, depending on system configurations and user preferences. By involving users in the validation process for conflicts, the present subject matter can leverage both automated system recommendation capabilities and human expertise to ensure the most accurate and updated representation of the offering structure. This approach may help in maintaining data quality, reducing errors, and keeping the hierarchy aligned with both system discoveries and user intentions over time.

FIG. 5B illustrates a method 500-1 for prompting a user for validating conflicting user preferred values of a hierarchical product parameter in a hierarchy of operational factors for an offering operating in a unified platform, according to an example implementation of the present subject matter. The order in which the method 500-1 is described is not intended to be construed as a limitation, and any number of the described method blocks may be combined in any order to implement the method 500-1, or an alternative method. Furthermore, the method 500-1 may be implemented by processor(s) or computing device(s) through any suitable hardware, non-transitory machine-readable instructions, or a combination thereof.

It may be understood that steps of the method 500-1 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 500-1 may be performed by the system 300 in the connected environment 100.

At step 510, the method 500-1 includes communicating conflict information and a conflicting user preferred value to a feedback loop mechanism. In an example, the communication may include a hierarchical product parameter identifier and attribute, current recorded user preferred value, and relevant context or metadata about the conflict. The feedback loop may prioritize and queue the communication based on factors such as conflict severity, hierarchical product parameter importance, or user preferences.

At step 512, the user may be prompted to validate the conflicting user preferred values of the recorded modified hierarchical product parameter. The user may be presented with the conflicting user-preferred values alongside the system-generated recommended values of the hierarchical product parameter to resolve the conflict. In an example, the user may also be presented with the context for the conflict, including historical data or related hierarchical product parameter information.

At step 514, the user may be allowed to validate the conflicting user preferred value. An interface may be provided for the user to review and respond to the prompt. The user may either approve or disapprove the conflicting user preferred value of the hierarchical product parameter. At step 516, the method 500-1 proceeds to check for approval or disapproval of the conflicting user preferred value.

In a scenario, the user may choose to approve the user preferred value of the hierarchical product parameter in the hierarchy of operational factors. In such scenarios, the modified hierarchical product parameter may be retained with the user preferred value of the hierarchical product parameter in the pin table, thereby confirming that the conflicting user preferred value is correct. In another scenario, the user may choose to disapprove the user preferred value of the hierarchical product parameter in the hierarchy of operational factors indicating that the conflicting user preferred value should be changed. In such scenarios, the recommended value of the hierarchical product parameter, derived from the plurality of connected data sources, may be selected. Upon selection of the recommended value by the user, the user preferred value of the hierarchical product parameter are overridden with the selected recommended value of the hierarchical product parameter. Alternatively, the user may choose an alternative input providing a new value different from both the conflicting user preferred value and recommended value. Additionally, the user may also have an option to defer his decision for review till a predefined time period. In case the user defers his decision, a follow-up prompt may be scheduled based on predefined rules or user preferences.

At step 518, an update process may be initiated based on the user's decision. The pin table may be updated based on the user validation. In an example, when approved, the current conflicting user preferred value may be marked as validated, with a timestamp and a user identifier. In another example, when disapproved, the conflicting user preferred value may be updated with the new value (either the recommended value or a user-provided alternative value). Further, when deferred, a flag may be added to the conflicting user preferred value indicating pending review. In an example, after completing the update in the pin table, confirmation may be provided to the user that their decision has been implemented. Further, the part table, which serves as the primary data store for the hierarchy of operational factors for the offering, may be updated to reflect the validated value.

The method ensures that user input is accurately captured and reflected in the pin table, while also leveraging the system's ability to discover and suggest potentially more accurate or updated values. By providing users with recommendations, choices, and contextual information, the present subject matter empowers them to make informed decisions about the data in the hierarchy of operational factors. The structured approach to update the part table maintains data integrity and consistency across the system, leading to a more accurate and reliable representation of the offering structure.

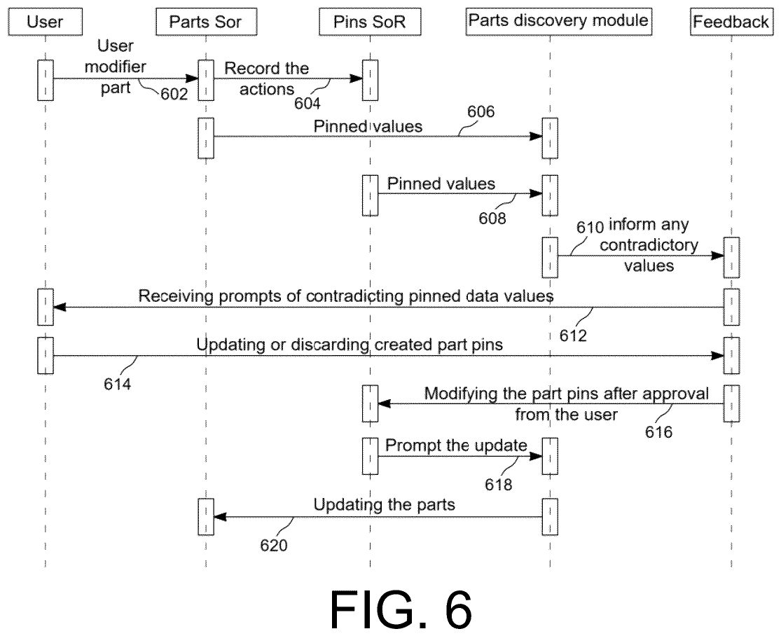

In one of the embodiments, the process of pinning the actions (as shown in FIG. 6) performed on the Part in the event hierarchy comprises modifying a Part 602 of a product or service hierarchy; recording pinned values and storing them as Part-pin 604; communicating the discovered Part 606 and the Part-pin records to the Part Discovery module 608; transmitting a command to the feedback loop if there is a conflicting issue regarding the Part-pin 610; sending a prompt to the user regarding the conflicting Part-pin 612; receiving the user review 614 (approval/disapproval) regarding the Part-pin; updating the Part-pin 616 after approval from the user; communicating to the Part Discovery module regarding the user review on the conflicting value 618; and updating the Part table 620 based on the user review on the conflicting value.

The Part Discovery module will prompt the user to review the pinned values after a significant time and only if there is a conflict between the discovered Part and pinned values recorded as the Part-pin. This periodical prompting allows the user to modify the Part easily, and such action is recorded. The user is asked to review the pinned value if any conflicting value is identified. The Part Discovery module provides suggestions during the review to the user so that the user can understand the suggested values and decide whether to approve the pinned value or reject the pinned value; the Part Discovery module updates the Part with the suggested values derived from another source. Suppose the user elects to go with the discovered Part value. In that case, the Part Discovery module will remove the pinned value, and the Part Discovery module, being autonomous, will modify that field as it sees fit. The Part Discovery module does not yield an altered pinned value since only user actions are recorded. Further, if the Part Discovery module finds that a discovered data value conflicts with a pinned value, and the user agrees with the discovered data value, the pinned value is removed. If, at a later run, the Part Discovery module finds another value to fit in this Part (previous Part-pin) attribute since the pinned value was removed, the Part Discovery module can change the value until the user makes another manual modification, which yields a new Part-pin.

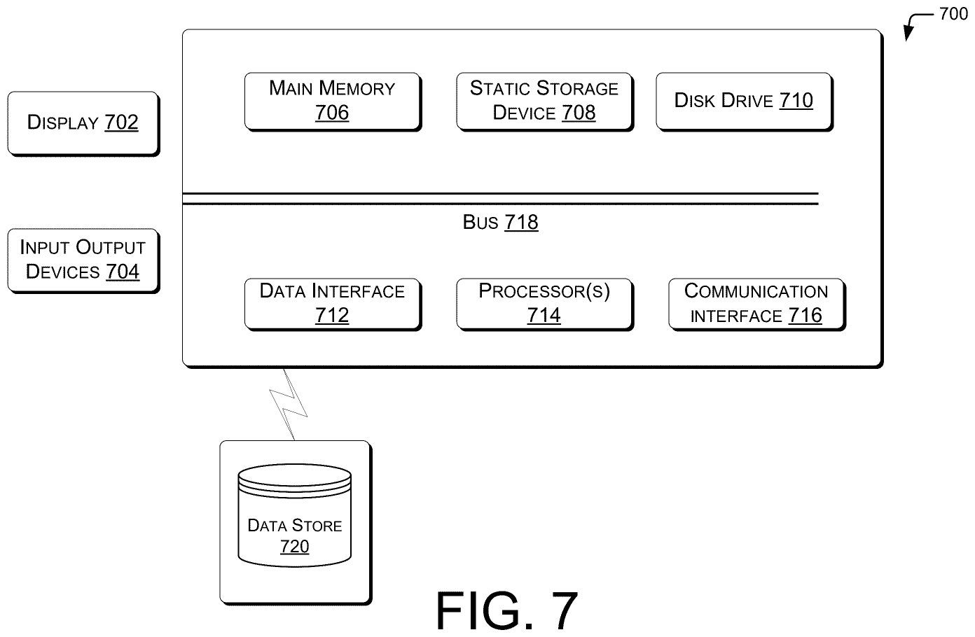

FIG. 7 is a block diagram of an illustrative computing system 700 suitable for implementing an embodiment of the present invention. Computing system 700 includes a bus 718 or other communication mechanism for communicating information, which interconnects subsystems and devices, such as processor 714, main memory 706 (e.g., RAM), static storage device 708 (e.g., ROM), disk drive 710 (e.g., magnetic or optical), communication interface 716 (e.g., modem or Ethernet card), display 702 (e.g., CRT or LCD), input device 704 (e.g., keyboard, and cursor control).

According to one embodiment of the present subject matter, the computing system 700 performs specific operations by the processor 714 executing one or more sequences of one or more instructions contained in main memory 706. Such instructions may be read into main memory 706 from another computer readable/usable medium, such as static storage device 708 or disk drive 710. In alternative embodiments, hard-wired circuitry may be used in place of or in combination with software instructions to implement the invention. Thus, embodiments of the present subject matter are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to the processor 714 for execution. Such a medium may take many forms, including but not limited to, non-volatile media and volatile media. Non-volatile media includes, for example, optical or magnetic disks, such as disk drive 710. Volatile media includes dynamic memory, such as main memory 706. A data store 720 may be accessed in a computer readable medium using a data interface 712.

Common forms of computer readable media includes, for example, a floppy disk, a flexible disk, a hard disk, a magnetic tape, any other magnetic medium, a CD-ROM, any other optical medium, punch cards, a paper tape, any other physical medium with patterns of holes, RAM, PROM, EPROM, FLASH-EPROM, any other memory chip or cartridge, or any other medium from which a computer can read.

In an embodiment of the present subject matter, execution of the sequences of instructions to practice the present subject matter is performed by a single computing system 700. According to other embodiments of the present subject matter, two or more computing systems 700 coupled by communication link (e.g., LAN, PTSN, or wireless network) may perform the sequence of instructions required to practice the invention in coordination with one another.

Computing system 700 may transmit and receive messages, data, and instructions, including program, i.e., application code, through communication link and communication interface 716. Received program code may be executed by processor 714 as it is received, and/or stored in disk drive 710, or other non-volatile storage for later execution.

In the foregoing specification, the present subject matter has been described with reference to specific embodiments thereof. It will, however, be evident that various modifications and changes may be made thereto without departing from the broader spirit and scope of the present subject matter. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A system to record modifications performed on a hierarchical product parameter in a hierarchy of operational factors for an offering operating in a unified platform, the system comprising:
a processor to:
receive a request from a user to modify the hierarchical product parameter in the hierarchy of operational factors, wherein the hierarchical product parameter is an operational factor associated with the offering within the hierarchy of operational factors;
process the request for the modification of the hierarchical product parameter to obtain a modified hierarchical product parameter, the modified hierarchical product parameter being indicative of user preferred values of the hierarchical product parameter;
record the modified hierarchical product parameter in a database for storing the modifications of the hierarchical product parameter, wherein the modifications are recorded in a pin table in the database;
determine a conflict in the modifications associated with the modified hierarchical product parameter recorded in the pin table;
obtain recommended values associated with the modifications of the hierarchical product parameter, the recommended values of the hierarchical product parameter being derived from a plurality of connected data sources, each connected data source from amongst the plurality of connected data sources being operated in connection with the unified platform;
compare the user preferred values of the recorded modified hierarchical product parameter with recommended values of the hierarchical product parameter to identify inconsistent values of the hierarchical product parameter,
notify the user to validate the modifications based on the identified inconsistent values, wherein the notification includes recommended values of the hierarchical product parameter; and
update the pin table based on the user validation.

2. The system of claim 1, wherein the unified platform comprises at least one of a developer-end ecosystem and a user-end ecosystem.

3. The system of claim 1, wherein the hierarchy of operational factors is formed of:
a capability as a sub-unit of the offering, wherein the capability represents functions performed by the offering;
a feature as a sub-unit of the capability, wherein the feature represents an item configurable to perform a capability;
a microservice as a sub-unit of the feature, the microservice representing an executable piece of a programming file for performing the capability; and
a sub-module as a sub-unit of the microservice, the sub-module representing a set of programming code integrable in the microservice;
wherein the hierarchical product parameter comprises at least one of the capability, the feature, the microservice, and the sub-module.

4. The system of claim 1, wherein the offering operating in the unified platform comprises at least one of a product and a service.

5. The system of claim 1, wherein the modification of the hierarchical product parameter comprises at least one of an update in the dependency of the hierarchical product parameter, an addition of a link in the hierarchical product parameter, a deletion of a link associated with the hierarchical product parameter, and a modification in attributes of the hierarchical product parameter.

6. The system of claim 1, wherein the processor is to monitor the hierarchical product parameters in the hierarchy of operational factors to track the modifications on the hierarchical product parameters during operations at both the developer-end ecosystem and the user-end ecosystem.

7. The system of claim 1, wherein to update the pin table based on the user validation, the processor is to:
transmit the identified inconsistent values of the hierarchical product parameter to a feedback loop, wherein the feedback loop is configured to prompt the user to review the user preferred values of the recorded modified hierarchical product parameter.

8. The system of claim 1, wherein the user validation includes at least one of approval and disapproval of the user preferred values of the hierarchical product parameter in the hierarchy of operational factors.

9. The system of claim 8, wherein on approval of the user preferred values of the hierarchical product parameter, the processor is to:
retain the modified hierarchical product parameter with the user preferred values of the hierarchical product parameter in the pin table.

10. The system of claim 8, wherein on disapproval of the user preferred values of the hierarchical product parameter, the processor is to:
receive input from the user, wherein the input includes a selected recommended value of the hierarchical product parameter derived from the plurality of connected data sources associated with the hierarchical product parameter;
override the user preferred values of the hierarchical product parameter with the selected recommended value of the hierarchical product parameter; and
update the pin table.

11. A method for recording modifications performed on a hierarchical product parameter in a hierarchy of operational factors for an offering operating in a unified platform, the method comprising:
receiving a request from a user to modify the hierarchical product parameter in the hierarchy of operational factors, wherein the hierarchical product parameter is an operational factor associated with the offering within the hierarchy of operational factors;
processing the request for the modification of the hierarchical product parameter to obtain a modified hierarchical product parameter, the modified hierarchical product parameter being indicative of user preferred values of the hierarchical product parameter;
recording the modified hierarchical product parameter in a database for storing the modifications of the hierarchical product parameter, wherein the modifications are recorded in a pin table in the database;
determining a conflict in the modifications associated with the modified hierarchical product parameter recorded in the pin table;
obtaining recommended values associated with the modifications of the hierarchical product parameter, the recommended values of the hierarchical product parameter being derived from a plurality of connected data sources, each connected data source from amongst the plurality of connected data sources being operated in connection with the unified platform;
comparing the user preferred values of the recorded modified hierarchical product parameter with recommended values of the hierarchical product parameter to identify inconsistent values of the hierarchical product parameter,
notifying the user to validate the modifications based on the identified inconsistent values, wherein the notification includes recommended values of the hierarchical product parameter; and
updating the pin table based on the user validation.

12. The method of claim 11, wherein the hierarchy of operational factors is formed of:
a capability as a sub-unit of the offering, wherein the capability represents functions performed by the offering;
a feature as a sub-unit of the capability, wherein the feature represents an item configurable to perform a capability;
a microservice as a sub-unit of the feature, the microservice representing an executable piece of a programming file for performing the capability; and
a sub-module as a sub-unit of the microservice, the sub-module representing a set of programming code integrable in the microservice;
wherein the hierarchical product parameter comprises at least one of the capability, the feature, the microservice, and the sub-module.

13. The method of claim 11, wherein the modification of the hierarchical product parameter comprises at least one of an update in the dependency of the hierarchical product parameter, an addition of a link in the hierarchical product parameter, a deletion of a link associated with the hierarchical product parameter, and a modification in attributes of the hierarchical product parameter.

14. The method of claim 11, the method comprising:
monitoring the hierarchical product parameters in the hierarchy of operational factors to track the modifications on the hierarchical product parameters during operations at both a developer-end ecosystem and a user-end ecosystem.

15. The method of claim 11, wherein to update the pin table based on the user validation, the method comprising:
transmitting the identified inconsistent values of the hierarchical product parameter to a feedback loop, wherein the feedback loop is configured to prompt the user to review the user preferred values of the recorded modified hierarchical product parameter.

16. The method of claim 11, wherein the user validation includes at least one of approval and disapproval of the user preferred values of the hierarchical product parameter in the hierarchy of operational factors.

17. The method of claim 16, wherein on approval of the user preferred values of the hierarchical product parameter, the method comprising:
retaining the modified hierarchical product parameter with the user preferred values of the hierarchical product parameter in the pin table.

18. The method of claim 16, wherein on disapproval of the user preferred values of the hierarchical product parameter, the method comprising:
receiving input from the user, wherein the input includes a selected recommended value of the hierarchical product parameter derived from the plurality of connected data sources associated with the hierarchical product parameter;
overriding the user preferred values of the hierarchical product parameter with the selected recommended value of the hierarchical product parameter; and
updating the pin table.

19. A non-transitory computer-readable medium comprising instructions to record modifications performed on a hierarchical product parameter in a hierarchy of operational factors for an offering operating in a unified platform, the instructions being executable by a processing resource to:
receive a request from a user to modify the hierarchical product parameter in the hierarchy of operational factors, wherein the hierarchical product parameter is an operational factor associated with the offering within the hierarchy of operational factors;
process the request for the modification of the hierarchical product parameter to obtain a modified hierarchical product parameter, the modified hierarchical product parameter being indicative of user preferred values of the hierarchical product parameter;
record the modified hierarchical product parameter in a database for storing the modifications of the hierarchical product parameter, wherein the modifications are recorded in a pin table in the database;
determine a conflict in the modifications associated with the modified hierarchical product parameter recorded in the pin table;
obtain recommended values associated with the modifications of the hierarchical product parameter, the recommended values of the hierarchical product parameter being derived from a plurality of connected data sources, each connected data source from amongst the plurality of connected data sources being operated in connection with the unified platform;
compare the user preferred values of the recorded modified hierarchical product parameter with recommended values of the hierarchical product parameter to identify inconsistent values of the hierarchical product parameter,
notify the user to validate the modifications based on the identified inconsistent values, wherein the notification includes recommended values of the hierarchical product parameter; and
update the pin table based on the user validation.

20. The non-transitory computer-readable medium of claim 19, wherein to update the pin table based on the user validation, the instructions are executed by the processing resource to:
transmit the identified inconsistent values of the hierarchical product parameter to a feedback loop, wherein the feedback loop is configured to prompt the user to review the user preferred values of the recorded modified hierarchical product parameter, and wherein the user validation includes at least one of approval and disapproval of the user preferred values of the hierarchical product parameter in the hierarchy of operational factors.

21. The non-transitory computer-readable medium of claim 20, wherein on approval of the user preferred values of the hierarchical product parameter, the instructions are executed by the processing resource to:
retain the modified hierarchical product parameter with the user preferred values of the hierarchical product parameter in the pin table.

22. The non-transitory computer-readable medium of claim 20, wherein on disapproval of the user preferred values of the hierarchical product parameter, the instructions are executed by the processing resource to:
receive input from the user, wherein the input includes a selected recommended value of the hierarchical product parameter derived from the plurality of connected data sources associated with the hierarchical product parameter;
override the user preferred values of the hierarchical product parameter with the selected recommended value of the hierarchical product parameter; and
update the pin table.
